(19) United States
(12) Patent Application Publication
(10) Pub. No.: US 2026/0309951 A1
(43) Pub. Date: Oct. 8, 2026

(54) CONNECTION INTERFACES AND RELATED ASSEMBLIES

(71) Applicant: Outdoor Wireless Networks LLC, Richardson, TX (US)

(72) Inventors: Oscar F. Bran de León, Yuma, AZ (US); Thomas Marcouiller, Shakopee, MN (US)

(21) Appl. No.: 19/716,469

(22) Filed: Jun. 23, 2026

Related U.S. Application Data
(62) Division of application No. 18/313,803, filed on May 8, 2023.
(60) Provisional application No. 63/353,050, filed on Jun. 17, 2022.

(51) Int. Cl. G02B 6/44; G02B 6/38; H02G 3/08

(52) U.S. Cl. CPC G02B 6/4452; G02B 6/3897; G02B 6/4444; H02G 3/083

(57) ABSTRACT

The present application is directed to a connection interface assembly. The assembly includes a base module including a back wall defining the back of the base module and first and second opposite side walls that project forwardly from the back wall to a front of the base module, a cable connection module configured to be inserted into a module mounting location through the front of the base module, the cable connection module having a main body coupled to or integral with a front wall to which a plurality of cable connection components are mounted, and an enclosure including a fiber tray and a cover that is configured to engage the cable connection module to form an interior cavity and seal the fiber tray therein. Other connection interface assemblies are described herein.

### RELATED APPLICATION(S)

The present application is a divisional of U.S. patent application Ser. No. 18/313,803, filed May 8, 2023, which claims priority to and the benefit of U.S. Provisional Patent Application Ser. No. 63/353,050, filed Jun. 17, 2022, the disclosures of which are hereby incorporated herein in full.

### FIELD

The present invention relates to telecommunications equipment, and in particular, connection interfaces suitable for managing cables and related assemblies.

### BACKGROUND

Antenna towers are increasingly used in communications network to provide cellular or other wireless services. Remote radio heads (RRH) coupled to or integrated with the antennas at the top of the towers transmit signals through the antennas. See, e.g., FIG. 2. Typically, a feeder cable is routed up the tower to the RRH from a network base station at the bottom of the tower. The feeder cable carries transmission signals and optionally power between the base station and the RRH.

Increasingly, the antenna towers are part of a Fiber to the Antenna (FTTA) network—the feeder cable is an optical cable including optical fibers carrying optical signals to the RRH. In some cases, each RRH receives a separate feeder cable (e.g., a hybrid cable). In certain cases, each RRH receives a separate signal feeder cable (e.g., an optical cable) and a separate power cable (e.g., a coaxial cable). In other cases, a common cable (e.g., a hybrid cable) can be routed up the tower and separated near the top of the tower into pigtails or additional cables routed to the respective RRH.

FIG. 1 illustrates a known connection interface assembly 100 suitable for use in managing cables on an antenna tower in a FTTA network. Some exemplary connection interface assemblies are shown and described in U.S. Patent Publication No. 2021/0218233 to Bran de León et al., the disclosure of which is hereby incorporated herein by reference in its entirety. As shown in FIG. 1, the assembly includes multiple bracket modules 170 that may be stacked together to form a base bracket 110. Each bracket module 170 is configured to receive a cable connection module 130. A plurality of cable connection components 150 is mounted on the cable connection module 130. The cable connection components may include fiber optic adapters 152 which each include a first end for mating with a first fiber optic connector 154 and a second end for mating with a second fiber optic connector 154. In addition, each bracket module 170 includes a respective mechanism 121 for attaching the module 170 to another structure 120 such as a pole, wall, rail, or other surface. Improvements to connection interface assemblies for use in a FTTA network may be desired.

### SUMMARY

A first aspect of the present invention is directed to a connection interface assembly. The assembly includes a base module, a connection module, and an enclosure. The base module has a front and a back and includes a back wall defining the back of the base module and first and second opposite side walls that project forwardly from the back wall to a front of the base module. The base module defines a module mounting location between the first and second side walls. The cable connection module has a main body coupled to or integral with a front wall to which a plurality of cable connection components are mounted. The cable connection module also includes first and second opposite side walls that project rearwardly from the front wall. The cable connection module is configured to be inserted into the module mounting location through the front of the base module. The enclosure includes a fiber tray and a cover. The cover is configured to engage the cable connection module to form an interior cavity and seal the fiber tray therein.

Another aspect of the present invention is directed to a connection interface assembly. The assembly includes a base module, a cable connection module, and an extension cover. The base module has a front and a back and includes a back wall defining the back of the base module and first and second opposite side walls that project forwardly from the back wall to a front of the base module. The base module defines a module mounting location between the first and second side walls. The cable connection module has a main body coupled to or integral with a front wall to which a plurality of cable connection components are mounted. The cable connection module also includes first and second opposite side walls that project rearwardly from the front wall. The cable connection module is configured to be inserted into the module mounting location through the front of the base module. The extension cover includes a top member and a bottom member. The top and bottom members are configured to cooperate together to form an inner cavity sized and configured to contain the cable connection components that extend outwardly from the cable connection module when the top and bottom members are joined together.

Another aspect of the present invention is directed to a connection interface assembly. The assembly includes a base module, a cable connection module, and a mounting bracket assembly. The base module has a front and a back and includes a back wall defining the back of the base module and first and second opposite side walls that project forwardly from the back wall to a front of the base module. The base module defines a module mounting location between the first and second side walls. The cable connection module has a main body coupled to or integral with a front wall to which a plurality of cable connection components are mounted. The cable connection module also includes first and second opposite side walls that project rearwardly from the front wall. The cable connection module is configured to be inserted into the module mounting location through the front of the base module. The mounting bracket assembly is configured to secure the base module and a cable connection module to a mounting structure. The mounting bracket assembly includes a main bracket body and one or more attachment mechanisms. The main bracket body includes a plurality of protruding members extending outwardly therefrom, each protruding member configured to engage a corresponding aperture defined in the back wall of the base module.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a schematic representation of a known connection interface.

FIG. 2 is a schematic representation of an antenna tower site in a communications network in which connection interfaces according to embodiments of the present invention may be utilized.

FIG. 3A is a top perspective view of a connection interface according to embodiments of the present invention.

FIG. 3B is a bottom perspective view of the connection interface of FIG. 3A.

FIG. 3C is an exploded view of an enclosure of the connection interface of FIG. 3A.

FIG. 4 is a photograph of an exemplary connection interface according to embodiments of the present invention with the enclosure opened.

FIG. 5A is a bottom view of a connection interface assembly according to embodiments of the present invention.

FIG. 5B is an exploded top perspective view of the connection interface assembly of FIG. 5A.

FIG. 5C is an exploded bottom perspective view of the connection interface assembly of FIG. 5A.

FIG. 5D is a cross-sectional side view of the connection interface assembly of FIG. 5A.

FIG. 6A is a top perspective view of a connection interface assembly including an extension cover according to embodiments of the present invention.

FIG. 6B is a side view of the connection interface assembly of FIG. 6A.

FIG. 6C is a bottom perspective view of the connection interface assembly of FIG. 6A.

FIG. 6D is an exploded top perspective view of the connection interface assembly of FIG. 6A.

FIG. 6E is an exploded side view of the connection interface assembly of FIG. 6A.

FIG. 6F is a cross-sectional side view of the connection interface assembly of FIG. 6A.

FIG. 7A is a front perspective view of a connection interface assembly including a mounting bracket according to embodiments of the present invention.

FIG. 7B is a rear perspective view of the connection interface assembly of FIG. 7A.

FIG. 7C is an exploded perspective view of the connection interface assembly of FIG. 7A.

FIG. 8 is a perspective view of the mounting bracket for the connection interface assembly of FIGS. 7A-7C.

FIG. 9A is a side view of the connection interface assembly of FIGS. 7A-7C secured to a mounting structure according to embodiments of the present invention.

FIG. 9B is a top view of the connection interface assembly of FIG. 9A.

FIG. 10A is a photograph of an exemplary connection interface assembly secured to a mounting structure according to embodiments of the present invention

FIG. 10B is a photograph of exemplary connection interface assemblies stacked together and secured to a mounting structure according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components, or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

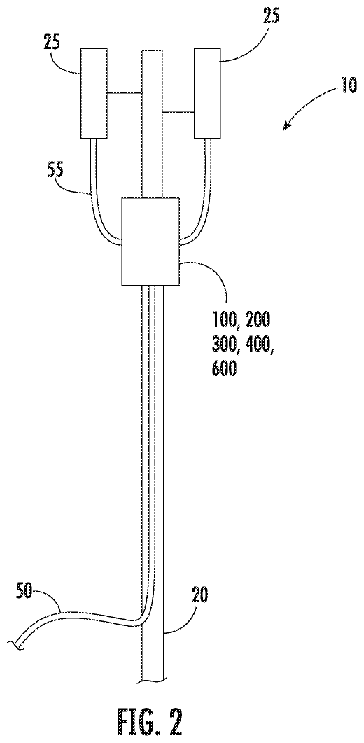

The connection interfaces and interface assemblies according to embodiments of the present invention and described herein are suitable for use in managing cables on an antenna tower in a FTTA network. FIG. 2 illustrates an example antenna tower site 10 in a communications network, such as a FTTA network. The site 10 includes an antenna tower 20 at which one or more antennas and one or more remote radio heads (RRH) 25 can be mounted. Each RRH 25 is adapted to transmit and receive signals to and from devices (e.g., mobile phone, smartphones, devices with wireless internet connectivity, etc.) of subscribers to the communications network. In certain examples, the RRH 25 may be integrated into the antennas.

In certain examples, one or more of the connection interface assemblies (or connection interface) 100, 200, 300, 400, 600 shown and described herein are mounted to the antenna tower 20. One or more feeder cables 50 (e.g., fiber optic cables, electrical cables, hybrid cables) extend between the connection interface assemblies 100, 200, 300, 400, 600 and the network base station. One end of the one or more cables 50 engages inner/rear ports of the cable connection components 150, 250 of the connection interface assemblies 100, 200, 300, 400, 600. Additional cables 55 connect each RRH 25 to outer/front ports of the cable connection components 150, 250 of the connection interface(s) 100, 200, 300, 400, 600.

According to some embodiments, the additional cables 55 can be routed from the RRH 25 to the connection interface 100, 200, 300, 400, 600 during an initial installation of the RRH 25, even if a feeder cable 50 has not yet been routed to the antenna tower 20. Subsequently, one or more feeder cables 50 can be routed to the antenna tower 20 to the connection interface 100, 200, 300, 400, 600 to connect to the additional cables 55. Accordingly, such a design reduces the amount of cable routing performed on the antenna tower 20 during subsequent installation of a feeder cable 50. The connection interface 100, 200, 300, 400, 600 can also be used at other positions in a communications network.

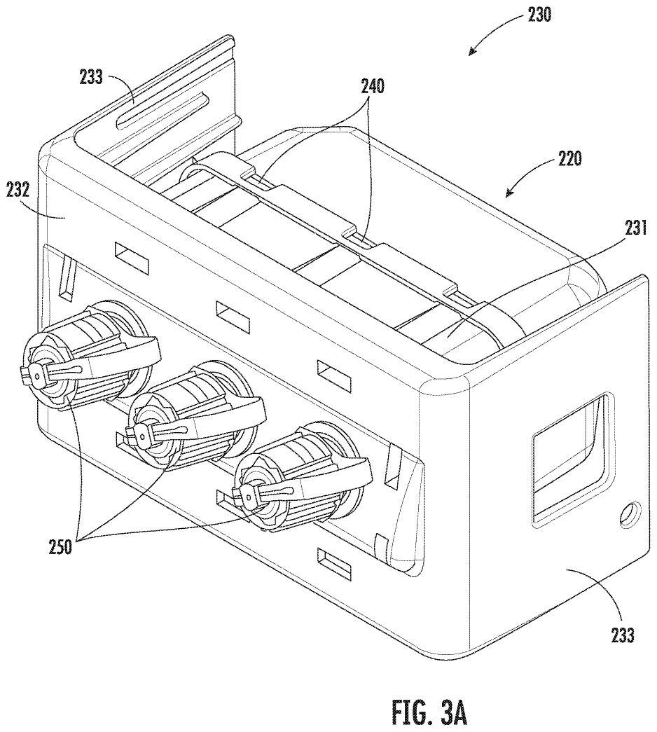

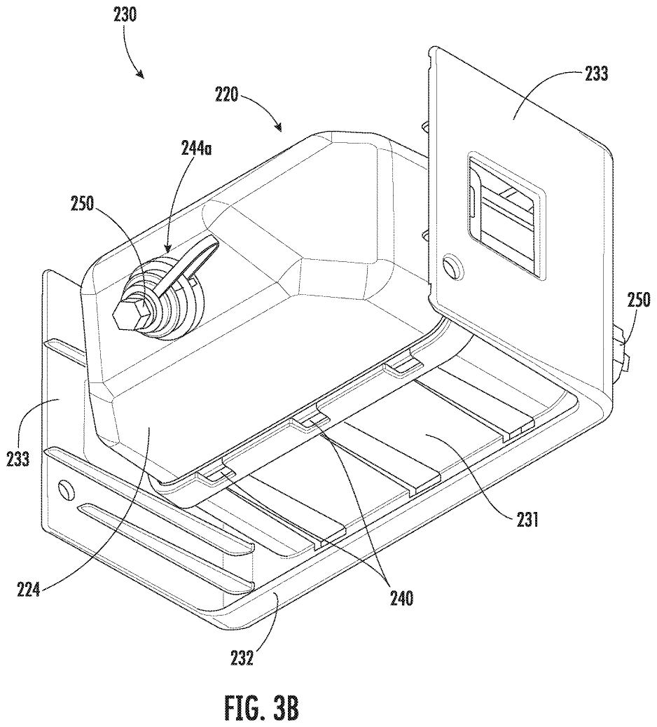

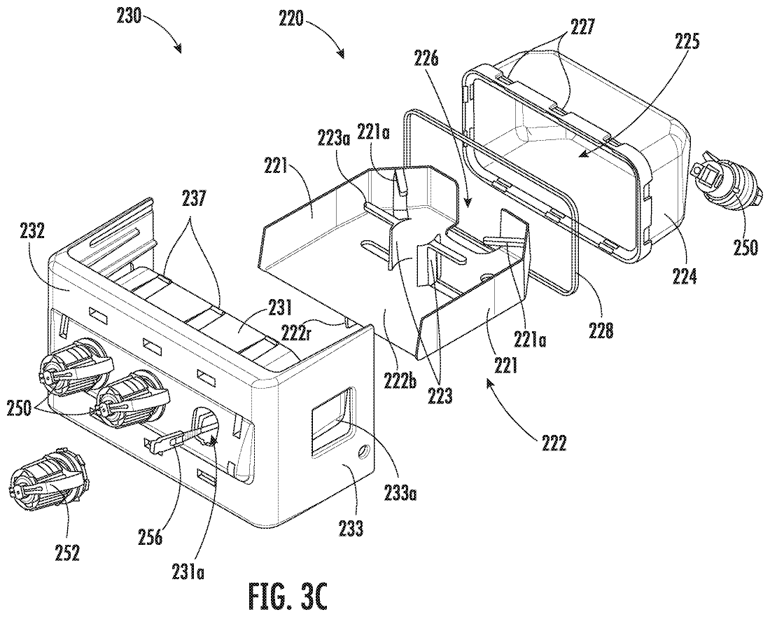

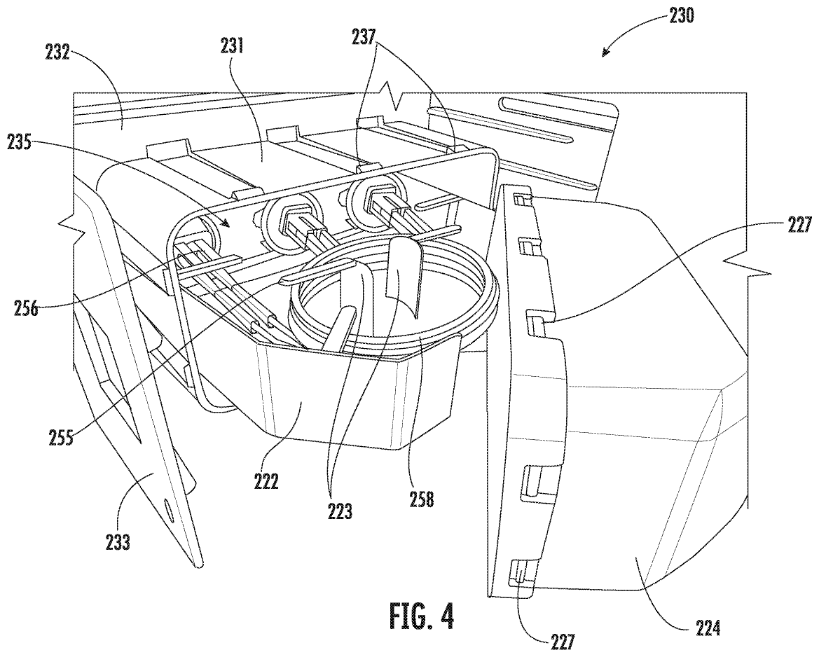

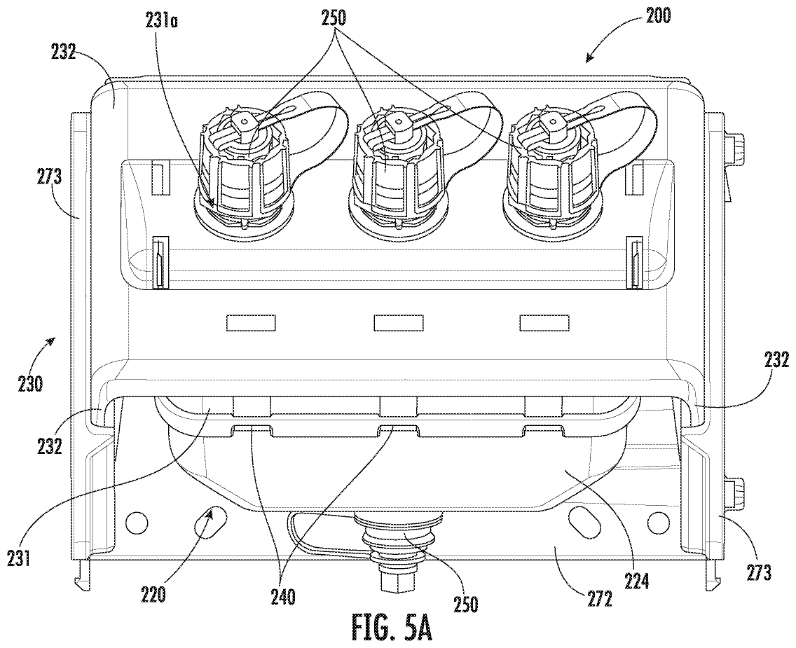

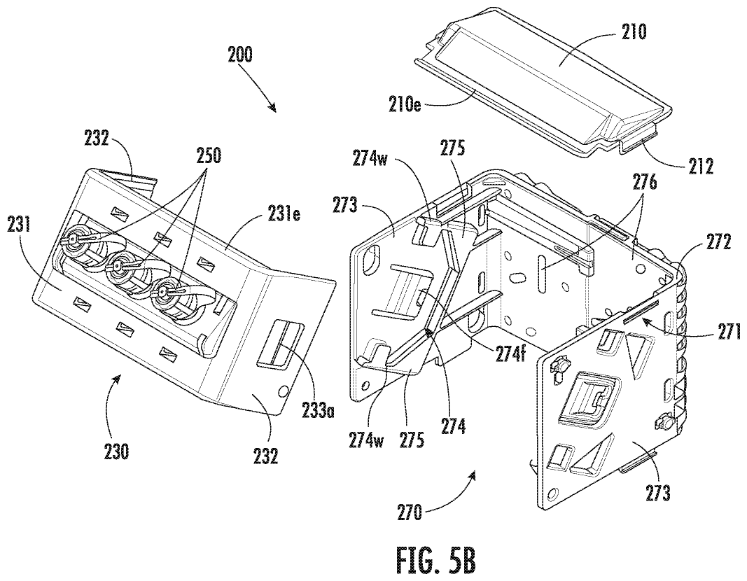

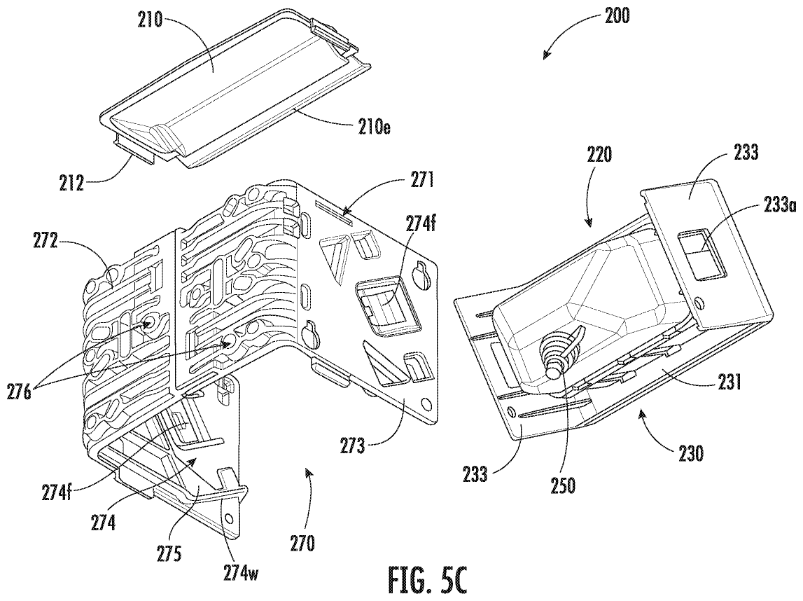

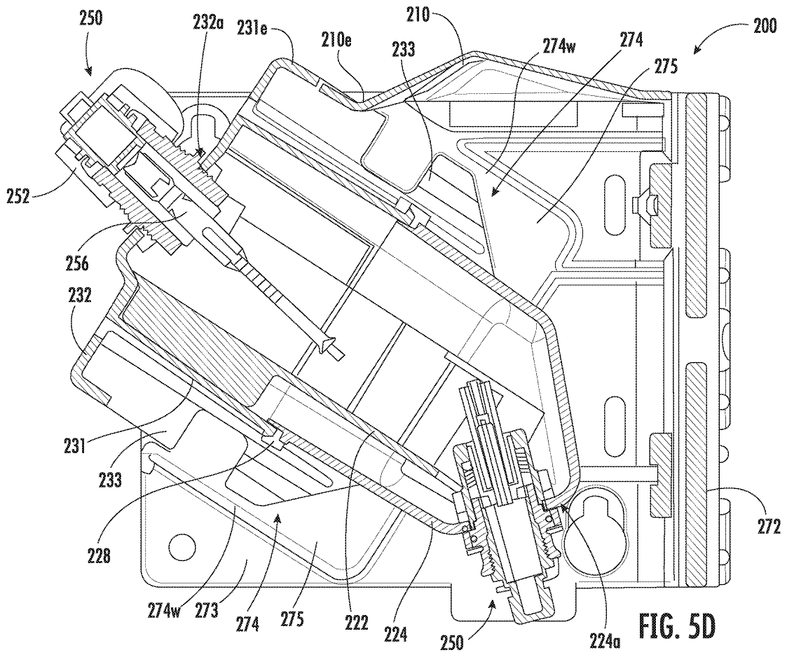

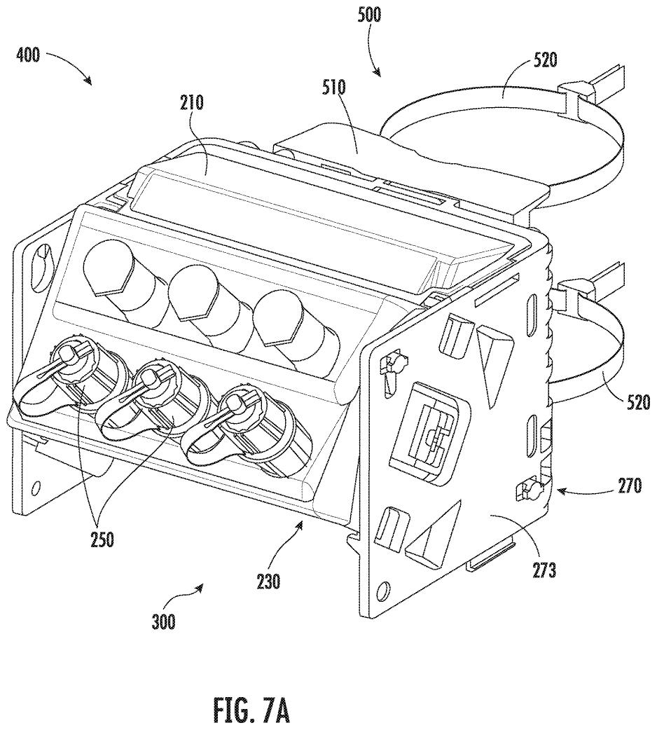

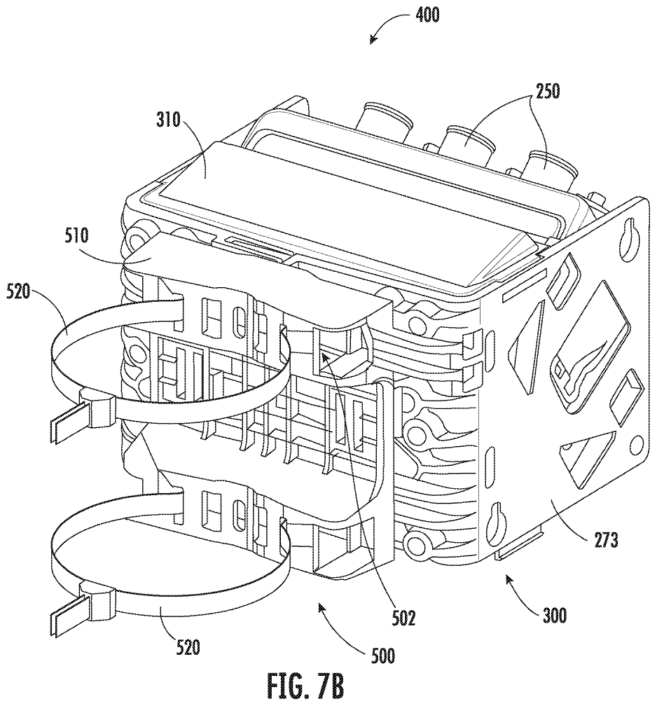

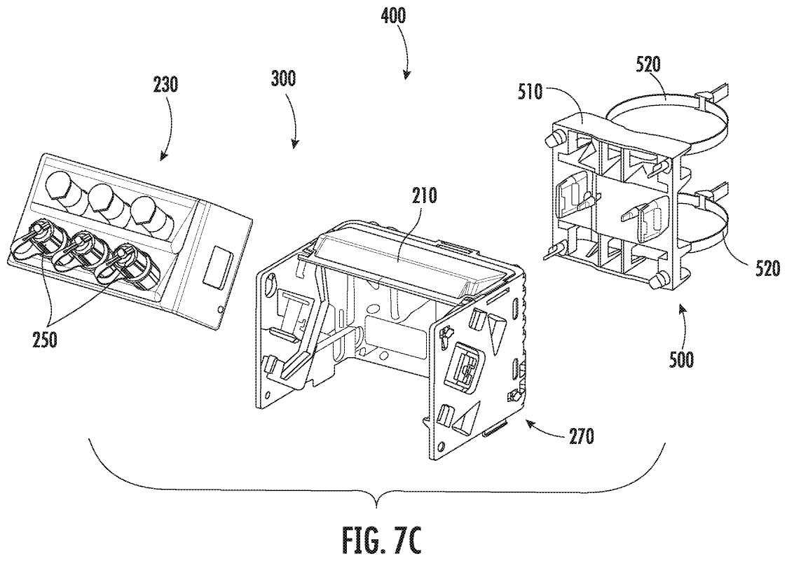

Referring now to FIGS. 3A-4, a cable connection module 230 according to embodiments of the present invention is illustrated. The cable connection module 230 is a component of a connection interface assembly 200 according to embodiments of the present invention and illustrated in FIGS. 5A-5D. The connection interface assembly 200 is similar to the assembly 100 and module 130 described herein. The assembly 200 differs from assembly 100 in that the assembly 200 includes an enclosure 220 integrated into the cable connection module 230. In some embodiments, the cable connection module 230 comprises a coarse wave division multiplexing (CWDM) module 255 (see, e.g., FIG. 7). In other embodiments, the cable connection module 230 comprises a dense wave division multiplexing (DWDM) module. The connection interface assembly 100 described above utilizes hardened (ruggedized) connectors 154 (e.g., IP-16 LC connectors) at both ends of the cable connection module 130 which are specifically designed for outdoor applications and harsh environments. In contrast, the CWDM or DWDM modules 255 utilized in the connection interface assembly 200 of the present invention are not designed for outdoor applications. The CWDM or DWDM module 255 allows one fiber optic cable 258 to be split into multiple fiber optic cables 258 (e.g., 2, 3, 4, . . . 12, 16, etc.), and thus, additional protection from certain environmental conditions (e.g., moisture, rain, snow, etc.) is needed. As discussed in further detail below, the connection interface assembly 200 of the present invention (i.e., the cable connection 230 and enclosure 220) provides a watertight seal to help protect the fiber optic cables 258 and CWDM or DWDM module 255 contained within the enclosure 220 from harsh environmental conditions (see, e.g., FIG. 4).

As shown in FIGS. 3A-3C and FIG. 4, the cable connection module 230 includes a main body (or bulkhead) 231 coupled to or integral with a front wall 232. The main body 231 defines an interior cavity 235. The cable connection module 230 also includes opposite first and second side walls 233 that project rearwardly from the front wall 232. In some embodiments, the front wall 232 and the first and second side walls 233 of the cable connection module 230 cooperate to define a C-shaped configuration when viewed from an end of the cable connection module 230. A rear of the cable connection module 230 is open. The main body 231 (and front wall 232) includes one or more openings or apertures 231a for receiving one or more of the cable connection components 250 (see, e.g., FIG. 3C). In other embodiments, the cable connection components 250 can be otherwise secured to the cable connection module 230. The cable connection components 250 may include, for example, fiber optic adapters 252 configured to connect to a fiber optic connector 256. In other examples, the cable connection components 250 include plug connectors (e.g., optical plug connectors, electrical plug connectors, hybrid plug connectors, etc.), optical cable fanouts, slice holders for optical and/or electrical splices, or other such cable interfaces. In some embodiments, the cable connection module 230 may be formed from a polymeric material, for example, polycarbonate. As mentioned above and discussed in further detail below, the cable connection module 230 further includes an enclosure 220. The enclosure 220 is configured to engage the main body 231.

FIG. 3C illustrates an exploded view of the cable connection module 230 and the enclosure 220. As shown in FIG. 3C, the enclosure 220 includes a fiber tray 222 and a cover 224. The fiber tray 222 includes a bottom 222b and one or more side walls 221. A front of the fiber tray 222 is open and at least a portion of a rear of the fiber tray 222 has an opening 226 sufficient to allow one or more fiber optic cables 258 from a cable connection component 250 to be routed into the tray 222. As shown in FIG. 4, the fiber tray 222 is sized and configured to hold the CWDM or DWDM module 255 and fiber optic cables 258 being routed and split therefrom.

At least a portion of the fiber tray 222 is configured to be slidably received and secured within the interior cavity 235 of the main body 231. For example, as shown in FIG. 4, in some embodiments, about half of the fiber tray 222 is received within the interior cavity 235 of the main body 231. In some embodiments, to assist in sliding the fiber tray 222 into the main body 231, the fiber tray 222 may comprise a rail 222r extending outwardly from the bottom 222b (see, e.g., FIG. 3C) which is configured to be received by a corresponding slot (not shown) along an inner surface of the main body 231.

In some embodiments, the fiber tray 222 may further include one or more cable organizing members 223. As shown in FIG. 3C, the cable organizing members 223 may extend inwardly and generally perpendicularly from the bottom portion 222b of the tray 222. As shown in FIG. 4, the cable organizing members 223 are positioned such that any excess length of the fiber optic cables 258 may be wrapped around the cable organizing members 223. In some embodiments, as shown in FIG. 3C and FIG. 4, each cable organizing member 223 may include an arm member 223a extending outwardly therefrom. The respective arm members 223a may help to contain or hold any excess length of the fiber optic cables 258 wrapped around the cable organizing members 223 and within the tray 222. In some embodiments, additional arm members 221a may extend inwardly from the one or more side walls 221. Similar to the arm members 223a extending from the cable organizing members 223, the additional arm members 221a extending from the side walls 221 may further help to contain or hold any excess length of the fiber optic cables 258 within the boundaries of the tray 222.

The cover 224 of the enclosure 220 has an outer wall that defines an interior cavity 225. The outer wall of the cover 224 has an opening or aperture 224a for receiving a cable connection components 250 (see, e.g., FIG. 3B). The cover 224 is configured to engage the main body 231 to surround the fiber tray 222 such that the fiber tray 222 is contained within the interior cavities 225, 235 of the cover 224 and the main body 231.

The enclosure 220 further includes an annular sealing gasket 228 that resides between the cover 224 and the main body 231 when secured together. The sealing gasket 228 helps form a watertight seal between the cover 224 and main body 231 to further protect the fiber optic cables 258 and CWDM or DWDM module 255 within the enclosure 220 from environmental conditions.

The cover 224 is secured to the main body 231 via one or more securing features 240. In some embodiments, the securing features 240 may comprise a snap-fit mechanism. For example, as shown in FIG. 3C and FIG. 4, in some embodiments, the cover 224 may include one or more recesses or apertures 227 and the main body 231 may include one or more corresponding latches or protrusions 237 that are configured to engage the one or more recesses or apertures 227 to secure the cover 224 to the main body 231. In other embodiments, the one or more recesses or apertures 227 may reside on the main body 231 and the corresponding latches or protrusions 237 may reside on the cover 224. In some embodiments, the components of the enclosure 220 (i.e., the fiber tray 222 and/or cover 224) may be formed from a polymeric material, for example, polycarbonate.

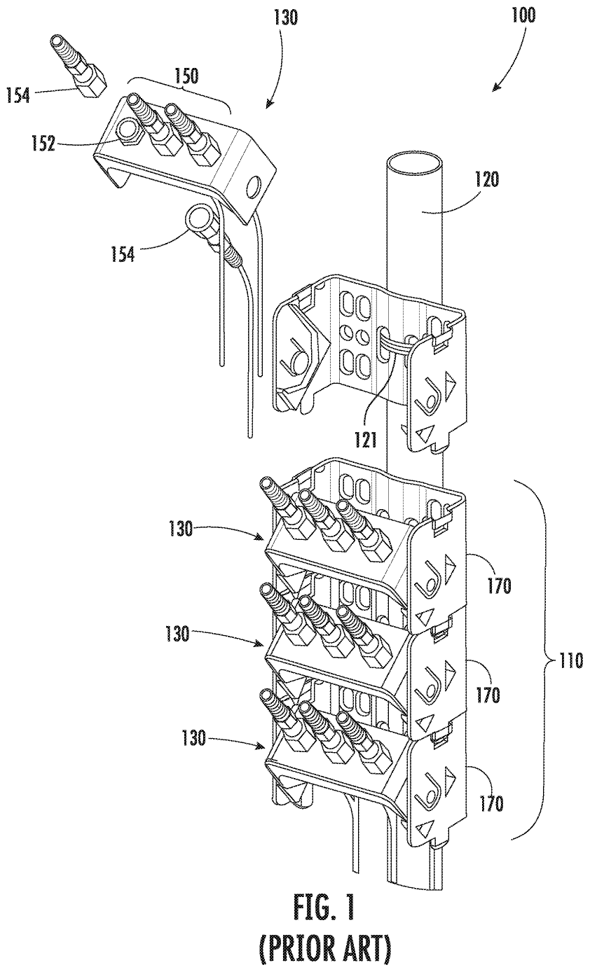

Referring now to FIGS. 5A-5D, in some embodiments, the cable connection module 230 is adapted to be inserted into a base module 270 which together define the connection interface assembly 200 according to embodiments of the present invention. Similar to the cable connection module 230, the base module 270 may be formed from a polymeric material, for example, polycarbonate. The base module 270 includes a back wall 272 and opposite first and second side walls 273 that project forwardly from the back wall 272. Similar to the cable connection module 230, the back wall 272 and the first and second side walls 273 of the base module 270 cooperate to define a C-shaped configuration when viewed from an end of the base module 270. The back wall 272 may comprise a plurality of mounting apertures 276 which may be used to secure the connection interface assembly 200 to a mounting structure 120 (e.g., a mounting pole) (see, e.g., FIG. 1 and FIGS. 9A-10B).

The cable connection module 230 is sized and configured to be inserted through the open front of the base module 270. In some embodiments, the base module 270 defines a pair of module mounting locations 274 between the first and second side walls 273 for receiving the cable connection module 230. In some embodiments, each of the module mounting locations 274 of the base module 270 may include a flexible finger 274f with an end or stop member. The flexible finger 274f is configured to snap into an aperture 233a defined in each side wall 233 of the cable connection module 230 as the cable connection module 230 is inserted into the base module 270. The snap-fit type securing mechanism (i.e., flexible finger 274f and corresponding aperture 233a) secures the cable connection module 230 to the base module 270. In other examples, the side walls 273 may define apertures and the cable connection module 230 may include the deflectable stop members. In other examples, the cable connection module 230 may otherwise secure the base module 270.

In addition, in some embodiments, the side walls 273 of the base module 270 include first and second receptacles 275 at the module mounting locations 274 for respectively receiving the side walls 233 of the cable connection module 230. In some embodiments, the first and second receptacles 275 are bounded by guide walls 274w that protrude inwardly from the side walls 273 of the base module 270. The guide walls 274w help to guide the side walls 233 of the cable connection module 230 as the cable connection module 230 is being inserted into the base module 270.

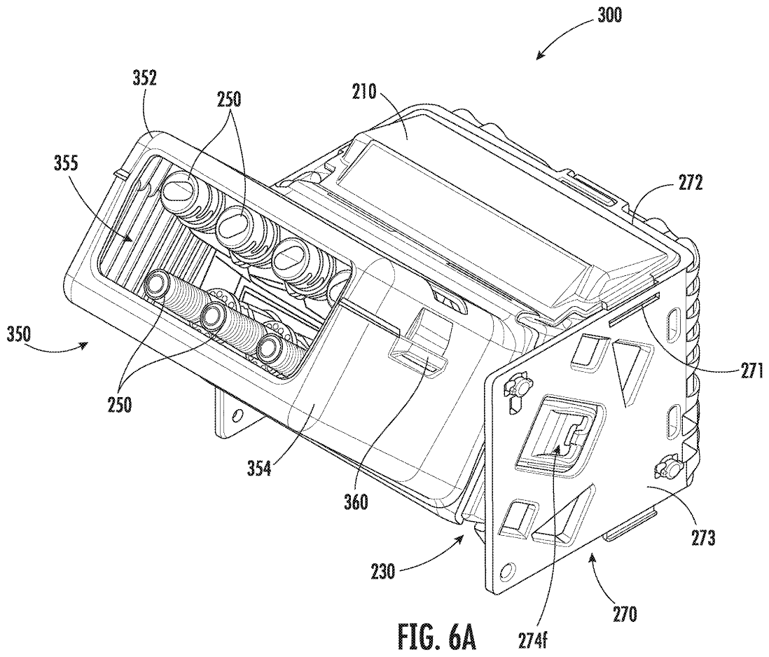

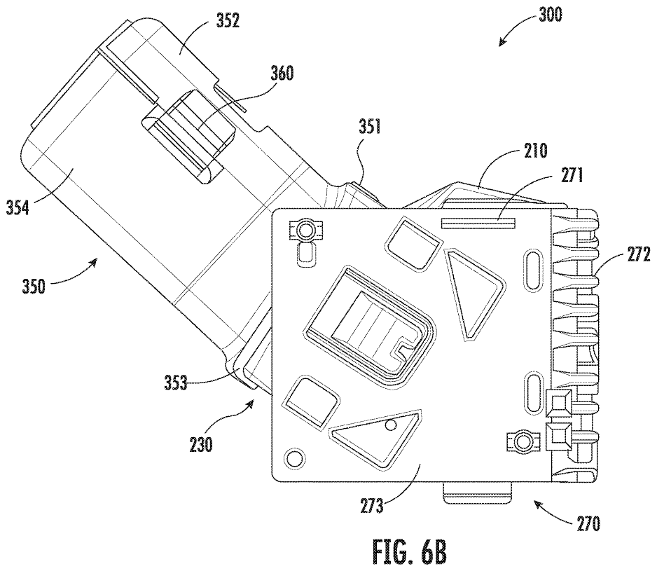

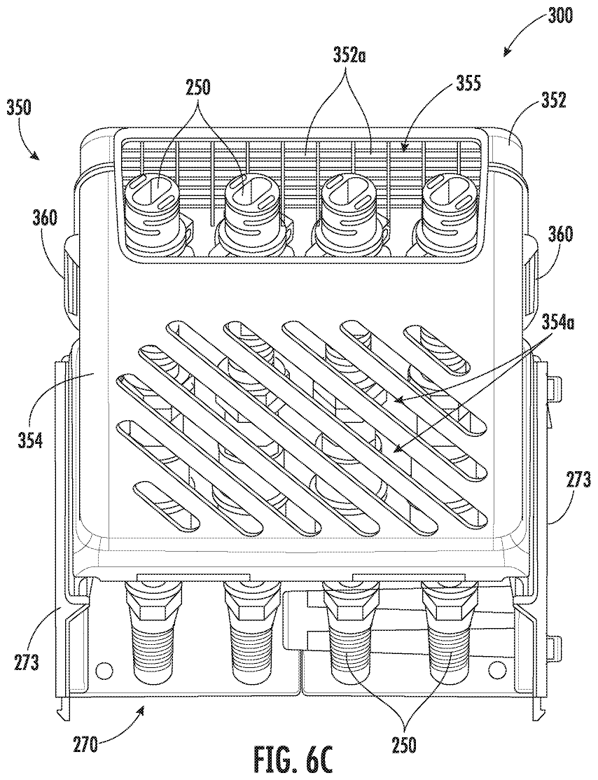

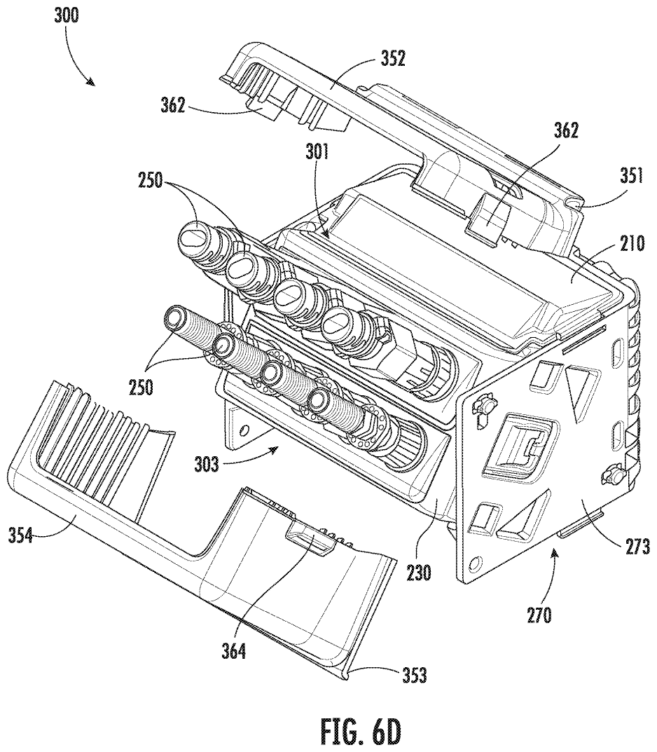

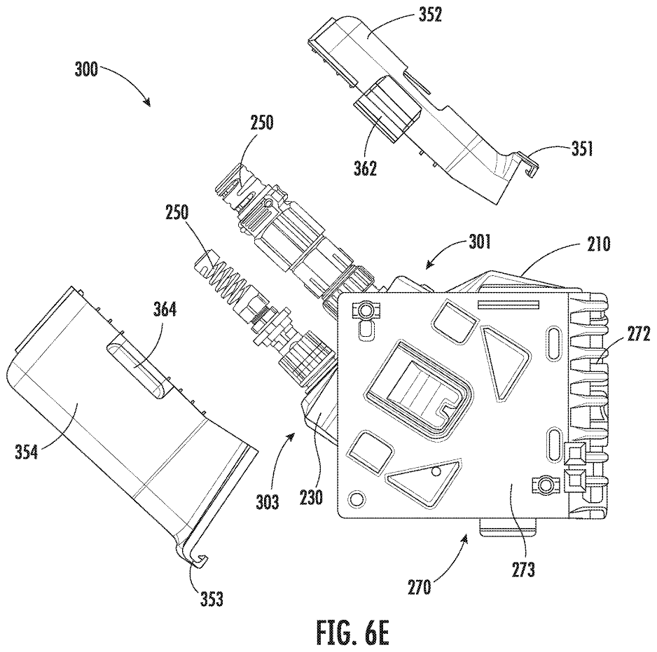

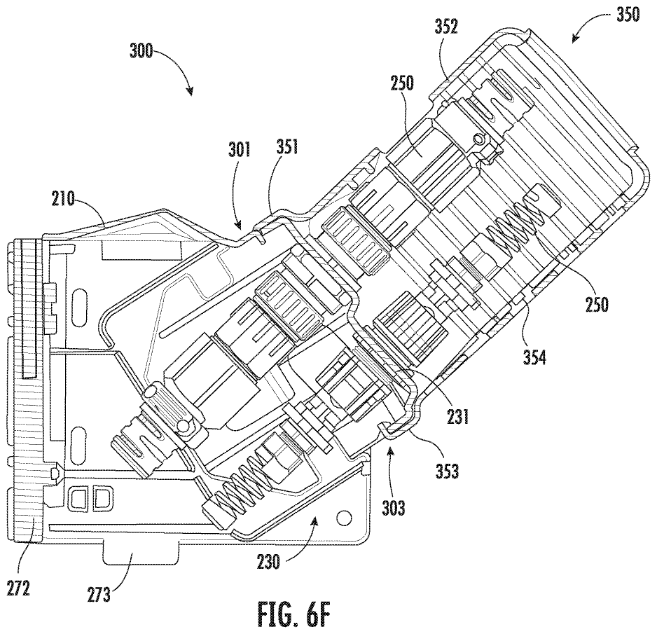

Still referring to FIGS. 5A-5D, in some embodiments, the connection interface assembly 200 of the present invention may further include a top cover 210. The top cover 210 is configured to engage the connection module 230 and/or the base module 270 to further protect the enclosure 220 residing therebetween. For example, in some embodiments, a front edge of the top cover 210 may be angled upwardly to define a lip or flanged edge 210e. The flanged front edge 210e is configured to engage a corresponding edge or lip 231e residing along a top inner surface of the cable connection module 230. In addition, in some embodiments, the top cover 210 further comprises a pair of deflectable arms 212, each arm 212 extending outwardly from opposite sides of the top cover 210. Each arm 212 is configured to snap into a corresponding aperture or slot 271 defined in each side wall 273 of the base module 270. After the cable connection module 230 has been inserted into and secured to the base module 270, the flanged front edge 210e of the top cover 210 may be engaged with the edge or lip 231e of the cable connection module 230. The top cover 210 may then pressed downwardly to snap each deflectable arm 212 into engagement with the respective slot 271 in the side wall 273 of the base module 270 (see also, e.g., FIGS. 6A-6B).

Referring now to FIGS. 6A-6F, a connection interface assembly 300 according to embodiments of the present invention is illustrated. Properties and/or features of the connection interface assembly 300 may be as described above in reference to the connection interface assembly 200 shown in FIGS. 5A-5D and duplicate discussion thereof may be omitted herein for the purposes of discussing FIGS. 6A-6F. In some embodiments, the connection interface assembly 300 differs from the connection interface assembly 200 described herein in that the connection interface assembly 300 includes an extension cover 350. As described in further detail below, the extension cover 350 is configured to protect the cable connection components 250 extending outwardly from the front wall 232 of the cable connection module 230 of connection interface assembly 300.

As shown in FIGS. 6A-6F, the extension cover 350 includes a top member 352 and a bottom member 354. The top and bottom members 352, 354 cooperate together to form an inner cavity 355. The inner cavity 355 is sized and configured to contain the cable connection components 250 that extend outwardly from the cable connection module 230 therein (i.e., when the top and bottom members 352, 354 are joined together).

In some embodiments, the top and bottom members 352, 354 of the extension cover 350 may be releasably secured together via one or more securing features 360. Similar to other securing features described herein, the one or more securing features 360 of the extension cover 350 may comprise a snap-fit mechanism, such as cantilevered latches. For example, as shown in FIGS. 6D-6E, the top member 352 may include one or more cantilever beams with tapered hooks 362. The cantilever beams/hooks 362 are each configured to deflect and snap into a corresponding recess 364 defined in opposing side walls of the bottom member 354 as the top member 352 and bottom member 354 are joined together. The snap-fit securing mechanism locks the top and bottom members 352, 354 together with the cable connection components 250 residing therebetween (i.e., within the formed inner cavity 355). In other examples, the side walls of the top member 352 may define recesses and the bottom member 354 may include the deflectable cantilever beams/hooks. In other examples, the top member 352 may otherwise be secured to the bottom member 354.

In some embodiments, the extension cover 350 may be configured to be secured to the cable connection module 230 of the connection interface assembly 300. As shown in FIG. 6B, FIG. 6D, FIG. 6E, and FIG. 6F, in some embodiments, the top and bottom members 352, 354 of the extension cover 350 may include respective hooking members 351, 353 extending outwardly therefrom. The hooking members 351, 353 are configured to engage corresponding recesses 301, 303 in the cable connection module 230. The hooking members 351, 353 (when engaged with a corresponding recess 301, 303) help prevent the extension cover 350 from being pulled away from the cable connection module 230 (and connection interface assembly 300). In some embodiments, the hooking members 351, 353 may extend along the width of the top and bottom members 352, 354 and the corresponding recesses 301, 303 may extend along the width of the cable connection module 230. In some embodiments, the hooking members 351, 353 and corresponding recesses 301, 303 may form a snap-fit mechanism. For example, the hooking members 351, 353 may be configured to deflect and snap into the recesses 301, 303 defined in the cable connection module 230.

As shown in FIG. 6C, in some embodiments, the top and bottom members 352, 354 may comprises a plurality of apertures 352a and/or slots 354a. The apertures and slots 352a, 354a help prevent dirt, debris, bugs, etc. from getting trapped within the extension cover 350. The apertures and slots 352a, 354a also help to reduce the overall weight of the extension cover 350. While FIG. 6C illustrates apertures 352a in the top member 352 and slots 354a in the bottom member 354, any configuration of apertures 352a and/or slots 354a may be used in the top and bottom members 352, 354 of the extension cover 350.

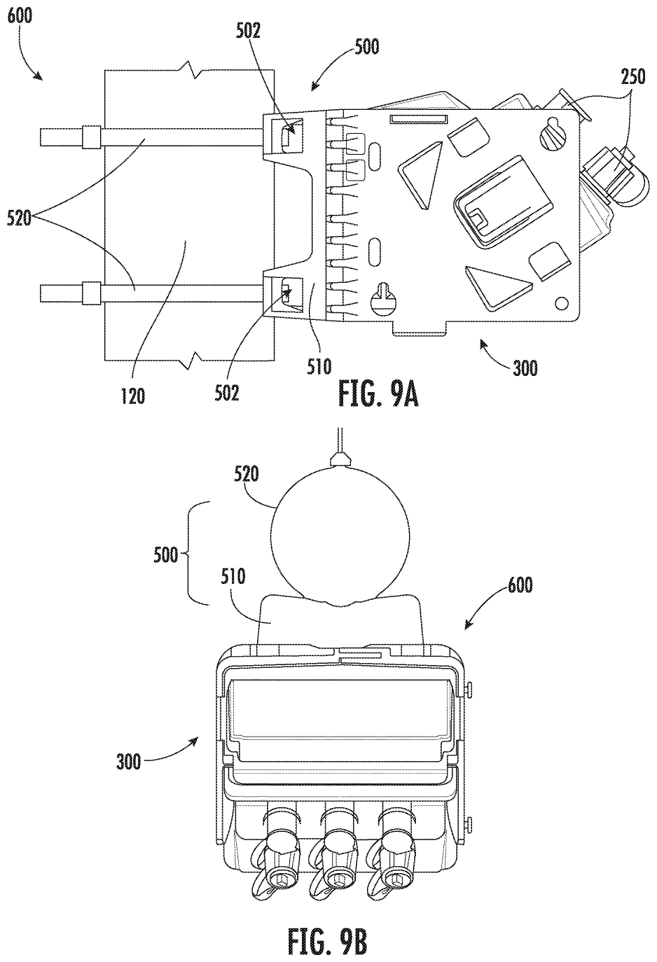

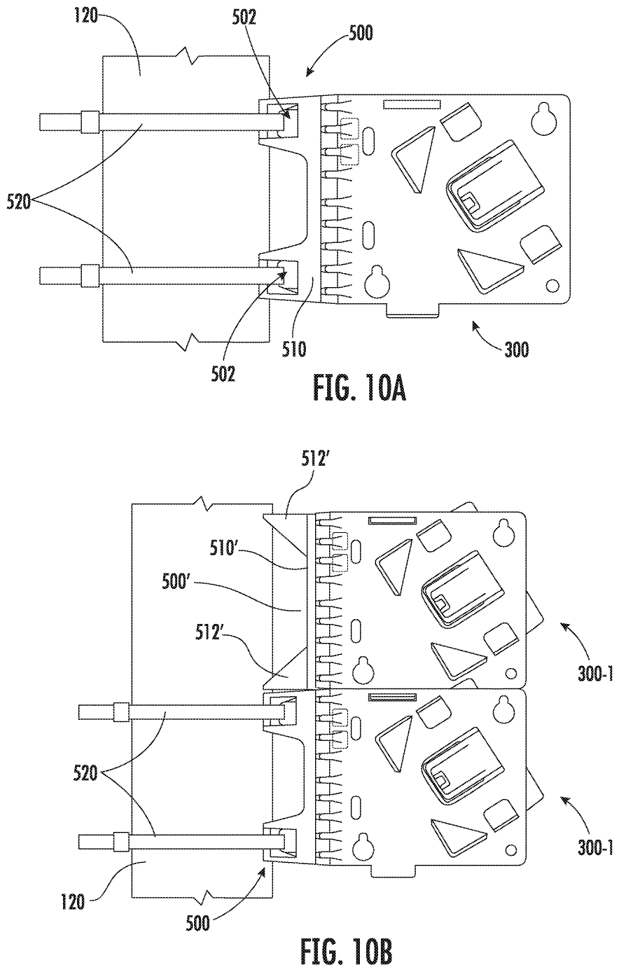

Referring now to FIGS. 7A-7C, a connection interface mounting assembly 400 according to embodiments of the present invention is illustrated. The connection interface mounting assembly 400 includes a separate mounting bracket assembly 500 that is configured to mount and secure the connection interface assemblies 200, 300 described herein to a mounting structure 120 (e.g., a mounting pole) (see, e.g., FIGS. 9A-10B). As discussed in further detail below, the mounting bracket assembly 500 provides additional space behind the connection interface assembly 300 (i.e., between the connection interface assembly 300 and the mounting structure 120). The additional space may allow telecommunications equipment to be mounted on the back side of the mounting structure 120.

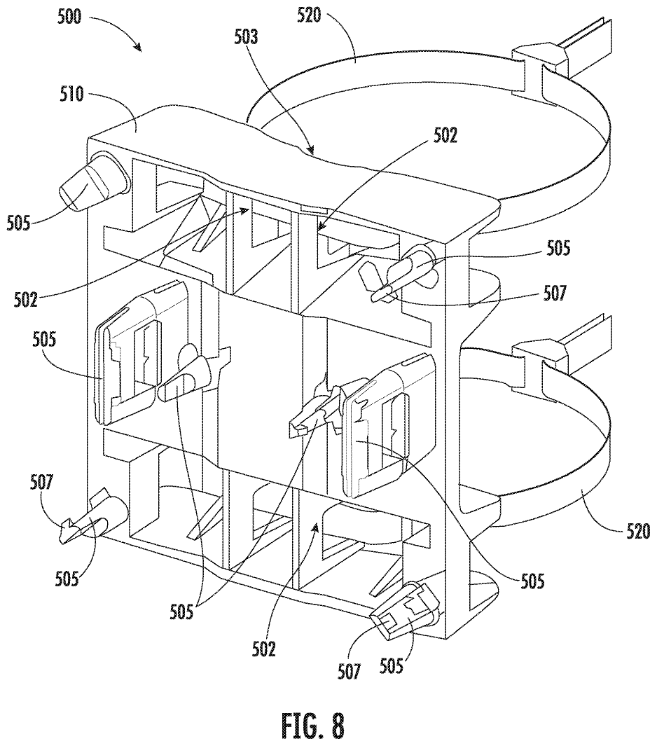

The mounting bracket assembly 500 is illustrated in FIG. 8. As shown in FIG. 8, the mounting bracket assembly 500 includes a main bracket body 510 and one or more attachment mechanisms 520. In some embodiments, the attachment mechanism 520 may include a cable tie, zip tie, or other such wrap-style fastener than can be threaded through apertures 502 in the main bracket body 510 and wrapped around the mounting structure 120 (see, e.g., FIGS. 9A-10B). In other embodiments, the attachment mechanism 520 may include screws, peg-type fasteners, latches, tabs, flanges, or other structures to aid in securing the connection interface assembly 200, 300 to the mounting structure 120.

The main bracket body 510 includes a plurality of protruding members 505 extending outwardly therefrom. The protruding members 505 are each configured to engage a corresponding aperture 276 defined in the back wall 272 of the base module 270 (see, e.g., FIG. 5B and FIG. 5C) to secure the main bracket body 510 to the base module 270. In some embodiments, one or more of the protruding members 505 and apertures 276 may form a snap-fit mechanism, such as the cantilevered latches described herein. For example, as shown in FIG. 8, some of the protruding members 505 may include tapered hooks 505a. As the main bracket body 510 and base module 270 are joined together, the protruding members 505 (and hooks 505a) are configured to deflect and snap into a respective aperture 276 in the back wall 272 of the base module 270, thereby securing the mounting bracket assembly 500 to the connection interface assembly 200, 300 (i.e., base module 270).

In some embodiments, the main bracket body 510 may further include one or more recesses 503 configured to receive a portion of the mounting structure 120. The recesses 503 may increase the contact surface area between the mounting bracket assembly 500 and the mounting structure 120, and thus, allowing for a more secure fit against the mounting structure 120. For example, in some embodiments, the recesses 503 may be concave to receive a cylindrical mounting pole 120. However, other shape profiles for the recesses 503 may be used. Similar to the cable connection module 230 and base module 270 described herein, the main bracket body 510 may be formed from a polymeric material, for example, polycarbonate.

FIGS. 9A-9B and FIGS. 10A-10B illustrate the mounting bracket assembly 500 securing the connection interface assembly 300 to the mounting structure 120 according to embodiments of the present invention. FIGS. 10A-10B are photographs of an exemplary connection interface assembly 300 secured to a mounting structure 120 utilizing an exemplary mounting bracket assembly 500. FIG. 10A shows a single connection interface assembly 300 secured to a mounting structure 120 according to embodiments of the present invention. In some embodiments, as shown in FIG. 10B, multiple connection interface assemblies 300-1, 300-2 may be stacked together and secured to the mounting structure 120. In some embodiments, the stacked connection interface assemblies 300-1, 300-2 may be secured to the mounting structure 120 by the mounting bracket assembly 500 described herein. In other embodiments, one of the connection interface assembly 300-1 may be secured to the mounting structure 120 utilizing the mounting bracket assembly 500 described herein and the other connection interface assembly 300-2 may contact the mounting structure 120 utilizing a mounting bracket assembly 500′ having an alternative main bracket body 510′. As shown in FIG. 10B, in some embodiments, the alternative main bracket body 510′ may not include apertures 502 for threading the wrap-style fastener, but instead may include opposing arm members 512′ that brace the mounting bracket assembly 500′ (and connection interface assembly 300-2) against the mounting structure 120.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1-22. (canceled)

23. A connection interface assembly, the assembly comprising:
a base module having a front and a back, the base module including a back wall defining the back of the base module and first and second opposite side walls that project forwardly from the back wall to a front of the base module, the base module defining a module mounting location between the first and second side walls;
a cable connection module having a main body coupled to or integral with a front wall to which a plurality of cable connection components are mounted, the cable connection module also including first and second opposite side walls that project rearwardly from the front wall, wherein the cable connection module is configured to be inserted into the module mounting location through the front of the base module; and
an extension cover comprising a top member and a bottom member, the top and bottom members being configured to cooperate together to form an inner cavity sized and configured to contain the cable connection components that extend outwardly from the cable connection module when the top and bottom members are joined together.

24. The connection interface assembly according to claim 23, wherein the top and bottom members of the extension cover are releasably secured together via one or more securing features comprising a snap-fit mechanism.

25. The connection interface assembly according to claim 24, wherein the snap-fit mechanism comprises cantilever shape joints.

26. The connection interface assembly according to claim 23, wherein the extension cover is configured to be secured to the cable connection module.

27. The connection interface assembly according to claim 26, wherein the top and bottom members of the extension cover comprise respective hooking members extending outwardly therefrom and configured to engage corresponding recesses in the cable connection module.

28. The connection interface assembly according to claim 23, wherein the top and bottom members of the extension cover comprises a plurality of apertures and/or slots.

29. The connection interface assembly according to claim 23, further comprising an enclosure, the enclosure comprising a fiber tray, an annular sealing gasket, and a cover, wherein the cover is configured to engage the cable connection module with the annular sealing gasket residing therebetween to form an interior cavity, the fiber tray being sealed within the interior cavity.

30. The connection interface assembly according to claim 29, wherein the fiber tray includes a bottom and one or more side walls, a front of the fiber tray is open and at least a portion of a rear of the fiber tray has an opening sufficient to allow one or more fiber optic cables from a cable connection component to be routed into the tray.

31. The connection interface assembly according to claim 29, wherein the fiber tray further comprises one or more cable organizing members.

32. The connection interface assembly according to claim 29, wherein the cover of the enclosure comprises an outer wall that defines an interior cavity, the outer wall having an opening for receiving a cable connection component.

33. The connection interface assembly according to claim 29, wherein the cover is secured to the main body via one or more securing features comprising a snap-fit mechanism.

34. The connection interface assembly according to claim 23, further comprising a top cover configured to engage the connection module and/or the base module.

35. The connection interface assembly according to claim 34, wherein a front edge of the top cover may be angled upwardly to define a lip or flanged edge, the flanged front edge being configured to engage a corresponding edge or lip residing along a top inner surface of the cable connection module, and wherein the top cover comprises a pair of deflectable arms, each arm extending outwardly from opposite sides of the top cover and configured to snap into a corresponding aperture or slot defined in each side wall of the base module.

36. The connection interface assembly according to claim 23, wherein the base module, the cable connection module, the enclosure, and/or the extension cover are formed from a polymeric material.

37-45. (canceled)

46. A connection interface assembly, the assembly comprising:
a base module including a back wall defining a back of the base module and opposing side walls that project forwardly from the back wall to a front of the base module;
a cable connection module configured to be inserted into the base module between the first and second side walls, the cable connection module having a plurality of cable connection components mounted thereto; and
an extension cover configured to contain the cable connection components that extend outwardly from the cable connection module.

47. The connection interface assembly according to claim 46, wherein the cable connection module has a front wall and opposing side walls that project rearwardly from the front wall.

48. The connection interface assembly according to claim 46, wherein the extension cover comprises a top member and a bottom member, the top and bottom members configured to engaged with each other to define an inner cavity that contains the cable connection components.

49. The connection interface assembly according to claim 46, wherein the extension cover is configured to be secured to the cable connection module.

50. The connection interface assembly according to claim 46, further comprising an enclosure including a fiber tray, an annular sealing gasket, and a cover, wherein the cover is configured to engage the cable connection module with the annular sealing gasket residing therebetween to form an interior cavity, the fiber tray being sealed within the interior cavity.

51. The connection interface assembly according to claim 46, further comprising a top cover configured to engage the connection module and/or the base module.
